(19) United States
(12) Patent Application Publication
(10) Pub. No.: US 2023/0411624 A1
(43) Pub. Date: Dec. 21, 2023

(54) ELECTRODE, ENERGY STORAGE DEVICE, AND ENERGY STORAGE APPARATUS

(71) Applicant: GS Yuasa International Ltd., Kyoto-shi, Kyoto (JP)

(72) Inventor: Fumiya KONDO, Kyoto (JP)

(21) Appl. No.: 18/034,420

(22) PCT Filed: Oct. 18, 2021
(86) PCT No.: PCT/JP2021/038340

§ 371 Date: Apr. 28, 2023

(30) Foreign Application Priority Data
Oct. 29, 2020 (JP) 2020-181551

(51) Int. Cl. H01M 4/62; H01M 4/133; H01M 4/134; H01M 4/587; H01M 4/38; H01M 50/209

(52) U.S. Cl. CPC H01M 4/622; H01M 4/133; H01M 4/134; H01M 4/587; H01M 4/386; H01M 4/625; H01M 50/209; H01M 2004/021

(57) ABSTRACT

An electrode according to one aspect of the present invention is an electrode for an energy storage device, including an active material layer containing an active material, fibrous carbon, a binder mainly containing an acrylic resin, and a polysaccharide polymer, in which the content ratio of the polysaccharide polymer to the acrylic resin on a mass basis is 0.01 or more and 0.40 or less.

### TECHNICAL FIELD

The present invention relates to an electrode, an energy storage device, and an energy storage apparatus.

### BACKGROUND ART

Nonaqueous electrolyte solution secondary batteries typified by lithium ion secondary batteries are widely used for electronic devices such as personal computers and communication terminals, motor vehicles, and the like since these secondary batteries have a high energy density. Also, capacitors such as lithium ion capacitors and electric double-layer capacitors, energy storage devices with electrolytes other than nonaqueous electrolyte solution used, and the like are also widely used as energy storage devices other than nonaqueous electrolyte solution secondary batteries.

Typically, an electrode of an energy storage device includes an active material layer containing an active material and a binder. This active material layer may contain therein a conductive agent for enhancing the electron conductivity. As the conductive agent, the use of fibrous carbon has also been studied, besides carbon black and the like. Patent Document 1 describes therein an electrode for a lithium-based battery, including carbon fibers of 5 to 200 nm in average fiber diameter and of 1 to 20 μm in average fiber length.

### PRIOR ART DOCUMENT

### Patent Document

Patent Document 1: JP-A-2009-16265

### SUMMARY OF THE INVENTION

### Problems to be Solved by the Invention

Fibrous carbon has advantages such as being capable of sufficiently enhancing the electron conductivity of an active material layer even in the case of a relatively low content as compared with a particulate conductive agent such as carbon black. Energy storage devices including an electrode that has an active material layer including the fibrous carbon may be, however, insufficient in capacity retention ratio after a charge-discharge cycle.

An object of the present invention is to provide an electrode including an active material layer containing fibrous carbon, which is capable of increasing the capacity retention ratio of an energy storage device after a charge-discharge cycle, an energy storage device including such an electrode, and an energy storage apparatus including such an energy storage device.

### Means for Solving the Problems

An electrode according to one aspect of the present invention is an electrode for an energy storage device, including an active material layer containing an active material, fibrous carbon, a binder mainly containing an acrylic resin, and a polysaccharide polymer, in which the content ratio of the polysaccharide polymer to the acrylic resin on a mass basis is 0.01 or more and 0.40 or less.

An energy storage device according to another aspect of the present invention includes the electrode.

An energy storage apparatus according to another aspect of the present invention includes a plurality of energy storage devices and includes one or more energy storage devices according to one aspect of the present invention.

### Advantages of the Invention

According to one aspect of the present invention, there can be provided an electrode including an active material layer containing fibrous carbon, which is capable of increasing the capacity retention ratio of an energy storage device after a charge-discharge cycle, an energy storage device including such an electrode, and an energy storage apparatus including such an energy storage device.

### BRIEF DESCRIPTION OF THE DRAWINGS

FIG. 1 is a perspective view illustrating an embodiment of an energy storage device.

FIG. 2 is a schematic diagram illustrating an embodiment of an energy storage apparatus including a plurality of energy storage devices.

FIG. 3 is a graph showing evaluation results of examples.

### MODE FOR CARRYING OUT THE INVENTION

First, outlines of an electrode, an energy storage device, and an energy storage apparatus disclosed in the present specification will be described.

An electrode according to one aspect of the present invention is an electrode for an energy storage device, including an active material layer containing an active material, fibrous carbon, a binder mainly containing an acrylic resin, and a polysaccharide polymer, in which the content ratio of the polysaccharide polymer to the acrylic resin on a mass basis is 0.01 or more and 0.40 or less.

An electrode according to one aspect of the present invention is an electrode including an active material layer containing fibrous carbon, which is capable of increasing the capacity retention ratio of an energy storage device after a charge-discharge cycle. Although the reason therefor is not clear, the following reason is presumed. While an acrylic resin is a binder that is expected to have the effect of inhibiting side reactions involving an electrolyte and an active material, in particular, a side reaction involving a hydrogen fluoride that may be included in the electrolyte and the active material, as a result of coating at least a part of the surfaces of the active material particles with the acrylic resin contained in the active material layer, the acrylic resin is low in affinity for fibrous carbon, and is not sufficient in terms of the dispersibility of the fibrous carbon. When the fibrous carbon as a conductive agent has low dispersibility in the active material layer, the fibrous carbon is unlikely to be uniformly disposed in the active material layer, and as a result, for example, the current collecting effect of the fibrous carbon for the active material becomes unlikely be efficiently produced, thereby causing the capacity retention ratio to tend to be decreased. In contrast, the dispersibility of the fibrous carbon is improved by containing a polysaccharide polymer with high affinity for the fibrous carbon in a predetermined proportion with respect to the acrylic resin. More specifically, the electrode according to one aspect of the present invention is presumed to be capable of increasing the capacity retention ratio of the energy storage device after a charge-discharge cycle, because of the high dispersibility of the fibrous carbon in the active material layer and the inhibition of side reactions involving the active material and the electrolyte.

It is to be noted that the “main component” refers to a component having the largest content on a mass basis.

The content ratio of the polysaccharide polymer to the fibrous carbon on a mass basis is preferably 1 or more and 20 or less. When the content ratio of the polysaccharide polymer to the fibrous carbon on a mass basis falls within the range mentioned above, the capacity retention ratio of the energy storage device after a charge-discharge cycle can be further increased by, for example, further enhancing the dispersibility of the fibrous carbon.

The content of the acrylic resin in the binder is preferably 90 mass % or more. When the content of the acrylic resin in the binder is 90% by mass or more, thereby, for example, the capacity retention ratio of the energy storage device after a charge-discharge cycle can be further increased by, for example, further inhibiting side reactions involving the active material and the electrolyte.

An energy storage device according to another aspect of the present invention is an energy storage device including the electrode. The energy storage device has a high capacity retention ratio after a charge-discharge cycle.

An energy storage apparatus according to another aspect of the present invention includes a plurality of energy storage devices and includes one or more energy storage devices according to one aspect of the present invention. The energy storage apparatus has a high capacity retention ratio after a charge-discharge cycle.

Hereinafter, an electrode according to an embodiment of the present invention, an energy storage device, a method for manufacturing the energy storage device, an energy storage apparatus, and other embodiments will be described in detail. The names of the respective constituent members (respective constituent elements) used in the respective embodiments may be different from the names of the respective constituent members (respective constituent elements) used in the background art.

### Electrode

The electrode according to an embodiment of the present invention is an electrode for an energy storage device. The electrode includes a substrate and an active material layer disposed directly on the negative substrate or over the substrate with an intermediate layer interposed therebetween. The electrode may be a positive electrode or a negative electrode, but is preferably a negative electrode.

The substrate has conductivity. Whether the positive substrate has “conductivity” or not is determined with the volume resistivity of 10⁷ Ω·cm measured in accordance with JIS-H-0505 (1975) as a threshold.

As the material of the substrate (positive substrate) in the case where the electrode is a positive electrode, a metal such as aluminum, titanium, tantalum, or stainless steel, or an alloy thereof is used. Among these, aluminum or an aluminum alloy is preferable from the viewpoint of electric potential resistance, high conductivity, and costs. Examples of the positive substrate include a foil, a deposited film, a mesh, and a porous material, and a foil is preferable from the viewpoint of costs. Accordingly, the positive substrate is preferably an aluminum foil or an aluminum alloy foil. Examples of the aluminum or aluminum alloy include A1085, A3003, A1N30, and the like specified in JIS-H-4000 (2014) or JIS-H-4160 (2006).

The average thickness of the positive substrate is preferably 3 μm or more and 50 μm or less, more preferably 5 μm or more and 40 μm or less, still more preferably 8 μm or more and 30 μm or less, particularly preferably 10 μm or more and 25 μm or less. When the average thickness of the positive substrate is within the above-described range, it is possible to increase the energy density per volume of the energy storage device while increasing the strength of the positive substrate. The “average thickness” of the positive substrate and the negative substrate described below refers to a value obtained by dividing a cutout mass in cutout of a substrate that has a predetermined area by a true density and a cutout area of the substrate.

As the material of the substrate (negative substrate) in the case where the electrode is a negative electrode, a metal such as copper, nickel, stainless steel, nickel-plated steel, or aluminum, an alloy thereof, a carbonaceous material, or the like is used. Among these metals and alloys, copper or a copper alloy is preferable. Examples of the negative substrate include a foil, a deposited film, a mesh, and a porous material, and a foil is preferable from the viewpoint of costs. Accordingly, the negative substrate is preferably a copper foil or a copper alloy foil. Examples of the copper foil include a rolled copper foil and an electrolytic copper foil.

The average thickness of the negative substrate is preferably 2 μm or more and 35 μm or less, more preferably 3 μm or more and 30 μm or less, still more preferably 4 μm or more and 25 μm or less, particularly preferably 5 μm or more and 20 μm or less. When the average thickness of the negative substrate falls within the above-described range, it is possible to increase the energy density per volume of the energy storage device while increasing the strength of the negative substrate.

The intermediate layer is a layer arranged between the substrate and the active material layer. The intermediate layer contains a conductive agent such as carbon particles to reduce contact resistance between the substrate and the active material layer. The configuration of the intermediate layer is not particularly limited, and includes, for example, a binder and a conductive agent.

The active material layer contains an active material, fibrous carbon, a binder, and a polysaccharide polymer.

The active material (positive active material) in the case where the electrode is a positive electrode can be appropriately selected from known positive active materials. As the positive active material for a lithium ion secondary battery, a material capable of storing and releasing lithium ions is usually used. Examples of the positive active material include lithium-transition metal composite oxides that have an α-NaFeO₂-type crystal structure, lithium-transition metal composite oxides that have a spinel-type crystal structure, polyanion compounds, chalcogenides, and sulfur. Examples of the lithium transition metal composite oxide that has an α-NaFeO₂ type crystal structure include Li[LiₓNi₍₁₋ₓ₎]O₂ (0≤x<0.5), Li[LiₓNi_{y}Co_{(1-x-y)}]O₂ (0≤x<0.5, 0<y<1), Li[LiₓCo₍₁₋ₓ₎]O₂ (0≤x<0.5), Li[LiₓNi_{y}Mn_{(1-x-y)}]O₂ (0≤x<0.5, 0<y<1), Li[LiₓNi_{y}Mn_{β}Co_{(1-x-y-β)}]O₂ (0≤x<0.5, 0<y, 0<β, 0.5<y+β<1), and Li[LiₓNi_{y}Co_{β}Al_{(1-x-y-β)}]O₂ (0≤x<0.5, 0<y, 0<β, 0.5<y+β<1). Examples of the lithium-transition metal composite oxides that have a spinel-type crystal structure include LiₓMn₂O₄ and LiₓNi_{y}Mn_{(2-y)}O₄. Examples of the polyanion compounds include LiFePO₄, LiMnPO₄, LiNiPO₄, LiCoPO₄, Li₃V₂(PO₄)₃, Li₂MnSiO₄, and Li₂CoPO₄F. Examples of the chalcogenides include titanium disulfide, molybdenum disulfide, and molybdenum dioxide. Some of atoms or polyanions in these materials may be substituted with atoms or anion species composed of other elements. The surfaces of these materials may be coated with other materials. In the active material layer (positive active material layer), one of these materials may be used singly, or two or more thereof may be used in mixture.

The positive active material is typically particles (powder). The average particle size of the positive active material is preferably 0.1 μm or more and 20 μm or less, for example. By setting the average particle size of the positive active material to be equal to or greater than the lower limit, the positive active material is easily manufactured or handled. By setting the average particle size of the positive active material to be equal to or less than the above upper limit, the electron conductivity of the positive active material layer is improved. It is to be noted that in the case of using a composite of the positive active material and another material, the average particle size of the composite is regarded as the average particle size of the positive active material. The term “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

A crusher or a classifier is used to obtain a powder with a predetermined particle size. Examples of a crushing method include a method in which a mortar, a ball mill, a sand mill, a vibratory ball mill, a planetary ball mill, a jet mill, a counter jet mill, a whirling airflow type jet mill, or a sieve or the like is used. At the time of crushing, wet type crushing in the presence of water or an organic solvent such as hexane can also be used. As a classification method, a sieve or a wind force classifier or the like is used based on the necessity both in dry manner and in wet manner.

The content of the positive active material in the active material layer is preferably 50% by mass or more and 99% by mass or less, more preferably 70% by mass or more and 98% by mass or less, and still more preferably 80% by mass or more and 95% by mass or less. When the content of the positive active material is in the above range, it is possible to achieve both high energy density and productivity of the active material layer.

The active material (negative active material) in the case where the electrode is a negative electrode can be appropriately selected from known negative active materials. As the negative active material for a lithium ion secondary battery, a material capable of absorbing and releasing lithium ions is usually used. Examples of the negative active material include metallic Li; metals or metalloids such as Si and Sn; metal oxides or metalloid oxides such as a silicon oxide, a titanium oxide, and a tin oxide; titanium-containing oxides such as Li₄Ti₅O₁₂, LiTiO₂, and TiNb₂O₇; a polyphosphoric acid compound; silicon carbide; and carbon materials such as graphite and non-graphitic carbon (easily graphitizable carbon or hardly graphitizable carbon). In the active material layer (negative active material layer), one of these materials may be used singly, or two or more of these materials may be used in mixture.

The term “graphite” refers to a carbon material in which an average grid distance (d₀₀₂) of a (002) plane determined by X-ray diffraction before charge-discharge or in a discharged state is 0.33 nm or more and less than 0.34 nm. Examples of the graphite include natural graphite and artificial graphite. Artificial graphite is preferable from the viewpoint that a material that has stable physical properties can be obtained.

The term “non-graphitic carbon” refers to a carbon material in which the average lattice distance (d₀₀₂) of the (002) plane determined by X-ray diffraction before charge-discharge or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol derived material.

In this regard, the “discharged state” in the carbon material (graphite and non-graphitic carbon) means a state discharged such that lithium ions that can be occluded and released in association with charge-discharge are sufficiently released from the carbon material that is the negative active material. For example, the “discharged state” refers to a state where an open circuit voltage is 0.7 V or higher in a monopolar battery that has, for use as a working electrode, a negative electrode containing a carbon material as a negative active material, and has metal Li for use as a counter electrode.

The “hardly graphitizable carbon” refers to a carbon material in which the d₀₀₂ is 0.36 nm or more and 0.42 nm or less.

The “easily graphitizable carbon” refers to a carbon material in which the d₀₀₂ is 0.34 nm or more and less than 0.36 nm.

Among these negative active materials, an active material containing a silicon element (silicon-based active material), such as Si (silicon simple substance), a silicon oxide, or a silicon carbide is preferable, and a silicon oxide (SiOₓ: 0<x<2, preferably 0.8≤x≤1.2) is more preferable. While the silicon-based active material has a high energy density, the silicon-based active material is likely to be isolated due to cracking or the like associated with repeated charge-discharge, and is greatly advantageous in increasing the capacity retention ratio by applying an embodiment of the present invention. The content of the silicon-based active material with respect to the whole active material layer is preferably 1% by mass or more and 90% by mass or less, more preferably 3% by mass or more and 50% by mass or less, further preferably 5% by mass or more and 20% by mass or less. In addition, the content of the silicon-based active material in the active material layer is preferably 1% by mass or more and 90% by mass or less, more preferably 3% by mass or more and 50% by mass or less, further preferably 5% by mass or more and 20% by mass or less.

As the negative active material, a carbon material is also preferable, and graphite is more preferable. In addition, the silicon-based active material and the carbon material are preferably used in combination. The content of the carbon material with respect to the whole active material layer is preferably 10% by mass or more and 99% by mass or less, more preferably 50% by mass or more and 97% by mass or less, further preferably 80% by mass or more and 95% by mass or less. In addition, the content of the carbon material as an active material in the active material layer is preferably 10% by mass or more and 99% by mass or less, more preferably 50% by mass or more and 97% by mass or less, further preferably 80% by mass or more and 95% by mass or less.

The content of the negative active material in the active material layer is preferably 60% by mass or more and 99% by mass or less, and more preferably 90% by mass or more and 98% by mass or less. When the content of the negative active material falls within the above range, it is possible to achieve both high energy density and productivity of the active material layer.

The negative active material is typically particles (powder). The average particle size of the negative active material can be, for example, 1 nm or more and 100 μm or less. When the negative active material is a carbon material, a titanium-containing oxide, or a polyphosphoric acid compound, the average particle size thereof may be 1 μm or more and 100 μm or less. When the negative active material is the silicon-based active material or the like, the average particle size thereof may be 1 nm or more and 1 μm or less. By setting the average particle size of the negative active material to be equal to or greater than the above lower limit, the negative active material is easily produced or handled. By setting the average particle size of the negative active material to be equal to or less than the above upper limit, the electron conductivity of the positive active material layer is improved. A crusher or a classifier is used to obtain a powder with a predetermined particle size. A crushing method and a powder classification method can be selected from, for example, the methods exemplified for the positive active material.

The fibrous carbon is a component that has electron conductivity and functions as a conductive agent. The fibrous carbon is not particularly limited as long as it is a fibrous carbon material. Examples of the fibrous carbon include carbon nanofibers, pitch-based carbon fibers, vapor growth carbon fibers, and carbon nanotubes (CNT), and CNTs that are graphene-based carbon can be suitably used. Examples of the CNT include single-walled carbon nanotubes (SWCNT) formed from a single layer of graphene, and multi-walled carbon nanotubes (MWCNT) formed from two or more layers (e.g., 2 to 60 layers, typically 2 to 20 layers) of graphene. The CNT may be a CNT containing SWCNT and MWCNT in arbitrary proportions (the ratio by mass of SWCNT:MWCNT is, for example, from 100:0 to 50:50, preferably from 100:0 to 80:20). Particularly preferred is a CNT substantially composed only of SWCNTs. The use of SWCNTs as the fibrous carbon is preferable as compared with the case of using MWCNTs, because the use facilitates providing an electrode capable of an energy storage device with an excellent capacity retention ratio associated with a charge-discharge cycle. In addition, the SWCNTs are preferable as compared with MWCNTs, because even the addition of the SWCNTs in a small amount makes a dense three-dimensional conductive network likely to be formed in the active material layer, thus allowing the addition of the CNTs to reduce adverse effects associated with the increased BET specific surface area of the active material layer. The structure of the graphene-based carbon is not particularly limited, and may be any of a chiral (helical) type, a zigzag type, and an armchair type. In addition, the graphene-based carbon may contain a catalyst metal element (e.g., Fe, Co, and platinum group elements (Ru, Rh, Pd, Os, Ir, Pt)) or the like used for the synthesis of the CNTs.

The aspect ratio (the average length to the average diameter) of the fibrous carbon is not particularly limited, but is, for example, 10 or more. The aspect ratio of the fibrous carbon is preferably 20 or more, more preferably 30 or more, still more preferably 40 or more, particularly preferably 50 or more from viewpoints such as exhibiting better electron conductivity. The upper limit of the aspect ratio of the fibrous carbon is not particularly limited, but is, from the viewpoints of handleability, ease of production, and the like, appropriately set to be approximately 2000 or less, and is preferably 1000 or less, more preferably 500 or less, still more preferably 200 or less, particularly preferably 100 or less. For example, fibrous carbon with an average aspect ratio of 10 or more and 200 or less (furthermore, 30 or more and 100 or less) is suitable.

The average diameter of the fibrous carbon is, for example, 1 nm or more. The average diameter of the fibrous carbon is preferably 3 nm or more, more preferably 5 nm or more, still more preferably 7 nm or more, particularly preferably 9 nm or more from viewpoints such as exhibiting better electron conductivity. The upper limit of the average diameter of the fibrous carbon is not particularly limited, but is appropriately set to be approximately 100 nm or less, and is preferably 80 nm or less, more preferably 50 nm or less, still more preferably 30 nm or less, particularly preferably 15 nm or less. For example, fibrous carbon with an average diameter of 1 nm or more and 100 nm or less (furthermore, 5 nm or more and 30 nm or less, typically 10 nm or more and 15 nm or less) is suitable.

The average length of the fibrous carbon is, for example, 0.5 μm or more. The average diameter of the fibrous carbon is preferably 0.8 μm or more, more preferably 1 μm or more, still more preferably 2 μm or more, particularly preferably 5 μm or more from viewpoints such as exhibiting better electron conductivity. The upper limit of the average length of the fibrous carbon is not particularly limited, but is appropriately set to be approximately 50 μm or less, and is preferably 30 μm or less, more preferably 20 μm or less, still more preferably 15 μm or less, particularly preferably 10 μm or less. For example, fibrous carbon with an average length of 1 μm or more and 20 μm or less (furthermore, 2 μm or more and 10 μm or less) is suitable.

It is to be noted that the average diameter and average length of the fibrous carbon are defined as average values for arbitrary ten sites of the fibrous carbon observed with an electron microscope.

Fibrous carbon can be obtained by, for example, a method in which a polymer is formed into a fibrous form by a spinning method or the like and heat-treated in an inert atmosphere, a vapor phase growth method in which an organic compound is reacted at a high temperature in the presence of a catalyst, or the like. As the fibrous carbon, fibrous carbon obtained by a vapor phase growth method (vapor phase growth method fibrous carbon) is preferable. Commercially available fibrous carbon can be used.

The content of the fibrous carbon in the positive active material layer is preferably 0.01% by mass or more and 3% by mass or less, more preferably 0.02% by mass or more and 1% by mass or less, still more preferably 0.03% by mass or more and 0.3% by mass or less, yet still more preferably 0.04% by mass or more and 0.1% by mass or less. The content of the fibrous carbon in the active material layer is set to be equal to or more than the lower limit mentioned above, thereby allowing the electron conductivity of the active material layer to be sufficiently enhanced. The content of the fibrous carbon in the active material layer is set to be equal to or less than the upper limit mentioned above, thereby, for example, allowing the content of the active material to be relatively increased, and allowing the increased energy density of the active material layer to be achieved. In addition, in the electrode according to an embodiment of the present invention, even when the content of the fibrous carbon in the active material layer is relatively low as described above, the capacity retention ratio of the energy storage device after a charge-discharge cycle is high because of the high dispersibility of the fibrous carbon.

The active material layer may include therein other conductive agents other than the fibrous carbon. Examples of the other conductive agents include carbon materials other than the fibrous carbon, such as carbon black. The content of the other conductive agents in the active material layer may be, however, preferably less than 3% by mass, more preferably less than 1% by mass, still more preferably less than 0.1% by mass, yet still more preferably substantially 0% by mass. As described above, the use of substantially only the fibrous carbon as the conductive agent reduces the content of the conductive agent, thereby allowing the energy density per volume of the electrode to be increased.

The binder mainly contains an acrylic resin. The acrylic resin may be a polymer that has a structural unit derived from a monomer having an acryloyl group or a methacryloyl group. The structural unit is preferably a structural unit represented by —CH₂—CR¹(COOR²)— (R¹ is a hydrogen atom or a methyl group, and R² is a hydrogen atom, an alkali metal atom, a hydrocarbon group having 1 to 4 carbon atoms, or an amino group). The content ratio of the structural unit to all of the structural units of the acrylic resin is, for example, 50 mol % or more, preferably 70 mol % or more, 90 mol % or more, or 98 mol % or more. The acrylic resin may be composed only of the structural unit mentioned above. Examples of the acrylic resin include acrylic acid-based resins, acryl resins, and acrylamide resins. Examples of the acrylic acid-based resins include polymers obtained from an acrylic acid, a sodium acrylate, a potassium acrylate, a methacrylic acid, a sodium methacrylate, a potassium methacrylate, or the like as a monomer, and copolymers obtained from these monomers and other monomers. Examples of the acryl resins include polymers obtained from an acrylic acid ester (such as a methyl acrylate and an ethyl acrylate) or a methacrylic acid ester (such as an ethyl methacrylate and an ethyl methacrylate) as a monomer, and copolymers obtained from these monomers and other monomers. Examples of the acrylamide resins include polymers obtained from an acrylamide or a methacrylamide as a monomer, and copolymers obtained from these monomers and other monomers. Among these examples, the acrylic acid-based resins are preferable. One of the acrylic resins may be used singly, or two or more thereof may be used in mixture.

The active material layer may include therein a binder other than the acrylic resin. Examples of the binder include: thermoplastic resins such as fluororesin (polytetrafluoroethylene (PTFE), polyvinylidene fluoride (PVDF), etc.), polyethylene, polypropylene, and polyimide; and elastomers such as ethylene-propylene-diene rubber (EPDM), sulfonated EPDM, styrene-butadiene rubber (SBR), and fluororubber.

The lower limit of the content of the acrylic resin in the binder is preferably 60% by mass, more preferably 70% by mass, still more preferably 80% by mass, yet still more preferably 90% by mass, particularly preferably 99% by mass. The binder may be composed only of the acrylic resin. The content of the acrylic resin in the binder is set to be equal to or more than the above lower limit, thereby, for example, further inhibiting side reactions involving the active material and the electrolyte to allow the capacity retention ratio of the energy storage device after a charge-discharge cycle to be further increased.

In particular, when the active material layer contains an SBR as another binder other than the acrylic resin, the above-mentioned effect of setting the content of the acrylic resin in the binder to be equal to or more than the above lower limit can be more reliably produced. From this viewpoint, the content of the SBR in the binder is preferably 3% by mass or less, particularly preferably 1% by mass or less, and most preferably, the binder contains no SBR. The SBR is composed of polymer particles that have a styrene monomer and a butadiene monomer copolymerized, and thus inferior in ability to coat the surface of an active material as compared with an acrylic resin. For this reason, the content of the SBR in the binder is set to be less than or equal to the above upper limit, thereby allowing the above-mentioned effect to be more reliably produced without inhibiting the acrylic resin action of coating the surface of the active material.

The content of the binder in the active material layer is preferably 1% by mass or more and 10% by mass or less, more preferably 1.5% by mass or more and 7% by mass or less, and still more preferably 2% by mass or more and 5% by mass or less in some cases. The content of the acrylic resin in the active material layer is preferably 1% by mass or more and 10% by mass or less, more preferably 1.5% by mass or more and 7% by mass or less, and still more preferably 2% by mass or more and 5% by mass or less in some cases. The content of the binder or acrylic resin is set to fall within the range mentioned above, thereby allowing the active material to be stably retained, and the capacity retention ratio of the energy storage device after a charge-discharge cycle to be further increased.

Examples of the polysaccharide polymer include cellulose derivatives such as a carboxymethylcellulose (CMC) and a methylcellulose, and a CMC is preferable. The polysaccharide polymer may be present in a state of a salt (such as alkali metal salt or ammonium salt). One of these polysaccharide polymer may be used singly, or two or more thereof may be used in mixture.

The content ratio of the polysaccharide polymer to the acrylic resin in the active material layer on a mass basis is 0.01 or more and 0.40 or less, preferably 0.02 or more and 0.35 or less, more preferably 0.05 or more and 0.30 or less, still more preferably 0.10 or more and 0.25 or less, yet still more preferably 0.15 or more and 0.25 or less. The content ratio of the polysaccharide polymer to the acrylic resin is set to be equal to or more than the above lower limit, thereby allowing the polysaccharide polymer to enhance the clispersibility of the fibrous carbon and increase the capacity retention ratio of the energy storage device after a charge-discharge cycle. In contrast the content ratio of the polysaccharide polymer to the acrylic resin is set to be equal to or more than the above lower limit, thereby allowing the content of the acrylic resin in the active material layer, and, for example, sufficiently inhibiting side reactions involving the active material and the electrolyte to allow the capacity retention ratio of the energy storage device after a charge-discharge cycle to be increased.

The content ratio of the polysaccharide polymer to the fibrous carbon in the active material layer on a mass basis is preferably 1 or more and 20 or less, more preferably 3 or more and 17 or less, still more preferably 6 or more and 14 or less. The content ratio of the polysaccharide polymer to the fibrous carbon is set to be equal to or more than the above lower limit, thereby allowing the polysaccharide polymer to further enhance the dispersibility of the fibrous carbon and further increase the capacity retention ratio of the energy storage device after a charge-discharge cycle. The content ratio of the polysaccharide polymer to the fibrous carbon is set to be equal to or more than the above lower limit, thereby allowing the content of the acrylic resin in the active material layer, and, for example, further sufficiently inhibiting side reactions involving the active material and the electrolyte to allow the capacity retention ratio of the energy storage device after a charge-discharge cycle to be further increased.

The content of the polysaccharide polymer in the active material layer is preferably 0.01% by mass or more and 5% by mass or less, more preferably 0.05% by mass or more and 3% by mass or less, and still more preferably 0.2% by mass or more and 1% by mass or less in some cases. The content of the polysaccharide polymer is set to be equal to or more than the above lower limit, thereby allowing the dispersibility of the fibrous carbon to be sufficiently enhanced, and allowing the capacity retention ratio of the energy storage device after a charge-discharge cycle to be further increased. In addition, the content of the binder is set to be equal to or less than the above upper limit, thereby, for example, allowing the contents of the other components such as the active material to be increased, and allowing the energy density, the capacity retention ratio, and the like to be increased.

The total content of the binder and polysaccharide polymer in the active material layer is preferably 1% by mass or more and 10% by mass or less, more preferably 2% by mass or more and 7% by mass or less, still more preferably 2.5% by mass or more and 5% by mass or less, and yet still more preferably 3.0% by mass or more in some cases. The total content of the binder and polysaccharide polymer is set to be equal to or more than the above lower limit, thereby for example, further enhancing the retention of the active material, the dispersibility of the fibrous carbon, and the like to cause the capacity retention ratio of the energy storage device after a charge-discharge cycle to tend to be further increased. In addition, the total content of the binder and polysaccharide polymer is set to be equal to or less than the above upper limit, thereby, for example, allowing the contents of the other components such as the active material to be increased, and allowing the energy density and the like to be increased.

The active material layer may further include other components. Examples of the other components include fillers. Examples of the filler include polyolefins such as polypropylene and polyethylene, inorganic oxides such as silicon dioxide, alumina, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, and barium sulfate, nitrides such as aluminum nitride and silicon nitride, and substances derived from mineral resources, such as talc, montmorillonite, boehmite, zeolite, apatite, kaolin, mullite, spinel, olivine, sericite, bentonite and mica, or artificial products thereof. In the case of using a filler, the content of the filler in the active material layer can be 0.1% by mass or more and 8% by mass or less, and is typically preferably 5% by mass or less, more preferably 2% by mass or less. The technique disclosed herein can be preferably carried out in an aspect in which the active material layer does not contain a filler.

The active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Nb, or W as a component other than the positive active material particles, the conductive agent (fibrous conductive agent or the like), the binder, the thickener, and the filler.

The electrode can be produced, for example, by applying an electrode composite paste (positive composite paste or negative composite paste) to a substrate directly or via an intermediate layer, followed by drying. After the drying, pressing or the like may be performed, if necessary. The electrode composite paste includes an active material, fibrous carbon, a binder mainly containing an acrylic resin, a polysaccharide polymer, and if necessary, other optional components. The electrode composite paste usually further contains a dispersion medium.

### Energy Storage device

An energy storage device according to an embodiment of the present invention includes: an electrode assembly including a positive electrode, a negative electrode, and a separator; an electrolyte such as a nonaqueous electrolyte; and a case that houses the electrode assembly and the electrolyte. The electrode assembly is typically a stacked type obtained by stacking a plurality of positive electrodes and a plurality of negative electrodes with a separator interposed therebetween, or a wound type obtained by winding a positive electrode and a negative electrode stacked with a separator interposed therebetween. The electrolyte is present with the positive electrode, negative electrode, and separator impregnated with the electrolyte. A nonaqueous electrolyte secondary battery (hereinafter, also simply referred to as a “secondary battery”) will be described as an example of the energy storage device.

### Positive Electrode and Negative Electrode

At least one of the positive electrode and the negative electrode is an electrode according to an embodiment of the present invention described above. When one of the positive electrode and the negative electrode is an electrode other than an electrode according to an embodiment of the present invention described above, a conventionally known electrode can be used as such an electrode. Examples of the configuration of the conventionally known electrode can include the same configuration as an electrode according to an embodiment of the present invention described above, except for failing to meet the condition that “the active material layer contains an active material, fibrous carbon, a binder mainly containing an acrylic resin, and a polysaccharide polymer, and the content ratio of the polysaccharide polymer to the acrylic resin on a mass basis is 0.01 or more and 0.40 or less”.

In the secondary battery, the negative electrode is preferably the above-mentioned electrode according to an embodiment of the present invention. In this case, preferably, the active material of the negative electrode includes a silicon-based active material, and the active material of the positive electrode includes a lithium-transition metal composite oxide that has an α-NaFeO₂-type crystal structure. Such a secondary battery is high in energy density, and also high in capacity retention ratio after a charge-discharge cycle. It is to be noted that the content of the conductive agent in the active material layer of the positive electrode of such a secondary electrode is preferably 1% by mass or more and 10% by mass or less, more preferably 3% by mass or more and 9% by mass or less.

### Separator

The separator can be appropriately selected from known separators. As the separator, for example, a separator composed of only a substrate layer, a separator in which a heat resistant layer containing heat resistant particles and a binder is formed on one surface or both surfaces of the substrate layer, or the like can be used. Examples of the form of the substrate layer of the separator include a woven fabric, a nonwoven fabric, and a porous resin film. Among these forms, a porous resin film is preferable from the viewpoint of strength, and a nonwoven fabric is preferable from the viewpoint of liquid retaining property of the nonaqueous electrolyte. As the material of the substrate layer of the separator, a polyolefin such as polyethylene or polypropylene is preferable from the viewpoint of a shutdown function, and polyimide, aramid or the like is preferable from the viewpoint of resistance to oxidation and decomposition. As the substrate layer of the separator, a material obtained by combining these resins may be used.

The heat resistant particles included in the heat resistant layer preferably have a mass loss of 5% or less in the case of temperature increase from room temperature to 500° C. under the air atmosphere of 1 atm, and more preferably have a mass loss of 5% or less in the case of temperature increase from room temperature to 800° C. Inorganic compounds can be mentioned as materials whose mass loss is a predetermined value or less. Examples of the inorganic compounds include oxides such as iron oxide, silicon oxide, aluminum oxide, titanium dioxide, zirconium oxide, calcium oxide, strontium oxide, barium oxide, magnesium oxide and aluminosilicate; nitrides such as aluminum nitride and silicon nitride; carbonates such as calcium carbonate; sulfates such as barium sulfate; hardly soluble ionic crystals such as calcium fluoride, barium fluoride, barium titanate; covalently bonded crystals such as silicon and diamond; and substances derived from mineral resources, such as talc, montmorillonite, boehmite, zeolite, apatite, kaolin, mullite, spinel, olivine, sericite, bentonite and mica, and artificial products thereof. As the inorganic compounds, a simple substance or a complex of these substances may be used alone, or two or more thereof may be used in mixture. Among these inorganic compounds, silicon oxide, aluminum oxide, or aluminosilicate is preferable from the viewpoint of safety of the energy storage device.

The porosity of the separator is preferably 80% by volume or less from the viewpoint of strength, and is preferably 20% by volume or more from the viewpoint of discharge performance. The “porosity” herein is a volume-based value, which means a value measured with a mercury porosimeter.

### Nonaqueous Electrolyte

The nonaqueous electrolyte can be appropriately selected from known nonaqueous electrolytes. As the nonaqueous electrolyte, a nonaqueous electrolyte solution may be used. The nonaqueous electrolyte solution contains a nonaqueous solvent and an electrolyte salt dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, those in which some hydrogen atoms contained in these compounds are substituted with halogen may be used.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among these examples, EC is preferable.

Examples of the chain carbonate include diethyl carbonate (DEC), dimethyl carbonate (DMC), ethyl methyl carbonate (EMC), diphenyl carbonate, trifluoroethyl methyl carbonate, and bis(trifluoroethyl)carbonate. Among these examples, EMC is preferable.

As the nonaqueous solvent, it is preferable to use the cyclic carbonate or the chain carbonate, and it is more preferable to use the cyclic carbonate and the chain carbonate in combination. By using the cyclic carbonate, dissociation of the electrolyte salt can be promoted to improve ionic conductivity of the nonaqueous electrolyte solution. By using the chain carbonate, the viscosity of the nonaqueous electrolyte solution can be kept low. When the cyclic carbonate and the chain carbonate are used in combination, a volume ratio of the cyclic carbonate to the chain carbonate (cyclic carbonate:chain carbonate) is preferably in a range from 5:95 to 50:50, for example.

The electrolyte salt can be appropriately selected from known electrolyte salts. Examples of the electrolyte salt include a lithium salt, a sodium salt, a potassium salt, a magnesium salt, and an onium salt. Among these salts, the lithium salt is preferable.

Examples of the lithium salt include inorganic lithium salts such as LiPF₆, LiPO₂F₂, LiBF₄, LiClO₄, and LiN(SO₂F)₂, lithium oxalates such as lithium bis(oxalate)borate (LiBOB), lithium difluorooxalatoborate (LiFOB), and lithium bis(oxalate)difluorophosphate (LiFOP), and lithium salts having a halogenated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃, and LiC(SO₂C₂F₅)₃ Among these salts, an inorganic lithium salt is preferable, and LiPF₆ is more preferable.

The content of the electrolyte salt in the nonaqueous electrolyte solution is, at 20° C. under 1 atm, preferably 0.1 mol/dm³ or more and 2.5 mol/dm³ or less, more preferably 0.3 mol/dm³ or more and 2.0 mol/dm³ or less, still more preferably 0.5 mol/dm³ or more and 1.7 mol/dm³ or less, and particularly preferably 0.7 mol/dm³ or more and 1.5 mol/dm³ or less. When the content of the electrolyte salt is in the above range, it is possible to increase the ionic conductivity of the nonaqueous electrolyte solution.

The nonaqueous electrolyte solution may contain an additive, besides the nonaqueous solvent and the electrolyte salt. Examples of the additive include aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; vinylene carbonate, methylvinylene carbonate, ethylvinylene carbonate, succinic anhydride, glutaric anhydride, maleic anhydride, citraconic anhydride, glutaconic anhydride, itaconic anhydride, cyclohexanedicarboxylic anhydride; ethylene sulfite, propylene sulfite, dimethyl sulfite, methyl methanesulfonate, busulfan, methyl toluenesulfonate, dimethyl sulfate, ethylene sulfate, sulfolane, dimethyl sulfone, diethyl sulfone, dimethylsulfoxide, diethyl sulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, 1,3-propene sultone, 1,3-propane sultone, 1,4-butane sultone, 1,4-butene sultone, perfluorooctane, tristrimethylsilyl borate, tristrimethylsilyl phosphate, tetrakistrimethylsilyl titanate, lithium monofluorophosphate, and lithium difluorophosphate. One of these additives may be used, or two or more thereof may be used in mixture.

The content of the additive contained in the nonaqueous electrolyte solution is preferably 0.01% by mass or more and 10% by mass or less, more preferably 0.1% by mass or more and 7% by mass or less, still more preferably 0.2% by mass or more and 5% by mass or less, particularly preferably 0.3% by mass or more and 3% by mass or less, with respect to a total mass of the nonaqueous electrolyte solution. The content of the additive falls within the above range, thereby making it possible to improve capacity retention performance or cycle performance after high-temperature storage, and to further improve safety.

As the nonaqueous electrolyte, a solid electrolyte may be used, or a nonaqueous electrolyte solution and a solid electrolyte may be used in combination.

The solid electrolyte can be selected from any material with ionic conductivity, which is solid at normal temperature (for example, 15° C. to 25° C.), such as lithium, sodium and calcium. Examples of the solid electrolyte include sulfide solid electrolytes, oxide solid electrolytes, oxynitride solid electrolytes, and polymer solid electrolytes.

Examples of the lithium ion secondary battery include Li₂S—P₂S₅, LiI—Li₂S—P₂S₅, and Li₁₀Ge—P₂S₁₂ as the sulfide solid electrolyte.

The shape of the energy storage device of the present embodiment is not particularly limited, and examples thereof include cylindrical batteries, prismatic batteries, flat batteries, coin batteries and button batteries.

FIG. 1 shows an energy storage device 1 as an example of a prismatic battery. FIG. 1 is a view showing an inside of a case in a perspective manner. An electrode assembly 2 including a positive electrode and a negative electrode which are wound with a separator interposed therebetween is housed in a prismatic case 3. The positive electrode is electrically connected to a positive electrode terminal 4 via a positive electrode lead 41. The negative electrode is electrically connected to a negative electrode terminal 5 via a negative electrode lead 51.

### Method for Manufacturing Energy Storage Device

A method for manufacturing the energy storage device of the present embodiment can be appropriately selected from known methods. The manufacturing method includes, for example, preparing an electrode assembly, preparing an electrolyte, and housing the electrode assembly and the electrolyte in a case. The preparation of the electrode assembly includes: preparing a positive electrode and a negative electrode, and forming an electrode assembly by stacking or winding the positive electrode and the negative electrode with a separator interposed therebetween.

Housing the electrolyte in a case can be appropriately selected from known methods. For example, when a nonaqueous electrolyte solution is used for the electrolyte, the nonaqueous electrolyte solution may be injected from an inlet formed in the case, followed by sealing the inlet.

### Energy storage apparatus

The energy storage device of the present embodiment can be mounted as an energy storage unit (battery module) configured by assembling a plurality of energy storage devices 1 on a power source for automobiles such as electric vehicles (EV), hybrid vehicles (HEV), and plug-in hybrid vehicles (PHEV), a power source for electronic devices such as personal computers and communication terminals, or a power source for power storage, or the like. In this case, the technique of the present invention may be applied to at least one energy storage device included in the energy storage unit.

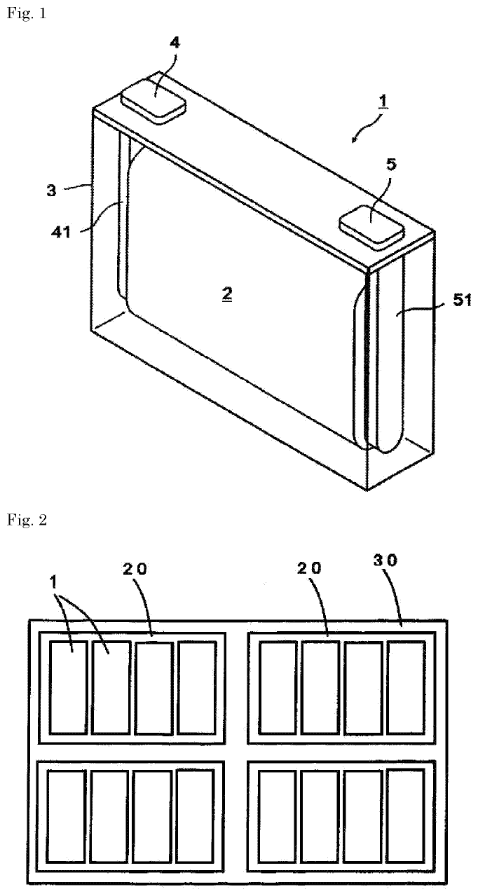

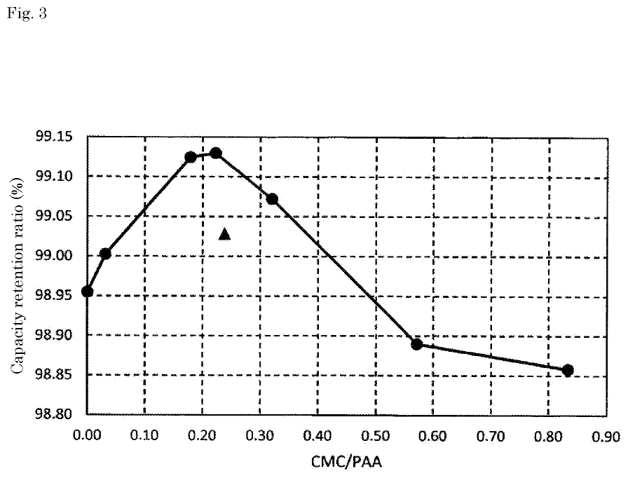

An energy storage apparatus according to an embodiment of the present invention is an energy storage apparatus including a plurality of energy storage devices and includes one or more energy storage devices according to an embodiment of the present invention. FIG. 2 shows an example of an energy storage apparatus 30 formed by assembling energy storage units 20 in each of which two or more electrically connected energy storage devices 1 are assembled. The energy storage apparatus 30 may include a busbar (not illustrated) for electrically connecting two or more energy storage devices 1, a busbar (not illustrated) for electrically connecting two or more energy storage units 20, and the like. The energy storage unit 20 or the energy storage apparatus 30 may include a state monitor (not illustrated) for monitoring the state of one or more energy storage devices.

### Other embodiments

It is to be noted that the energy storage device of the present invention is not limited to the embodiments described above, and various changes may be made without departing from the scope of the present invention. For example, the configuration according to one embodiment can be added to the configuration according to another embodiment, or a part of the configuration according to one embodiment can be replaced with the configuration according to another embodiment or a well-known technique. Furthermore, a part of the configuration according to one embodiment can be deleted. In addition, a well-known technique can be added to the configuration according to one embodiment.

In the above embodiment, although the case where the energy storage device is used as a nonaqueous electrolyte secondary battery (for example, lithium ion secondary battery) that can be charged and discharged has been mainly described, the type, shape, size, capacity, and the like of the energy storage device are arbitrary. The present invention can also be applied to capacitors such as various secondary batteries, electric double layer capacitors, and lithium ion capacitors.

While the electrode assembly with the positive electrode and the negative electrode stacked with the separator interposed therebetween has been described in the embodiment mentioned above, the electrode assembly may include no separator. For example, the positive electrode and the negative electrode may be brought into direct contact with each other, with a non-conductive layer formed on the active material layer of the positive electrode or negative electrode. In addition, the energy storage device according to the present invention can also be applied to an energy storage device in which the electrolyte is an electrolyte (an electrolyte including water as a solvent) other than the nonaqueous electrolyte.

### EXAMPLES

Hereinafter, the present invention will be described more specifically by way of examples, but the present invention is not limited to the following examples.

### Example 1

### Fabrication of Positive Electrode

A positive composite paste was prepared with the use of LiNi_{3/5}Co_{1/5}Mn_{1/5}O₂ as a positive active material, carbon black (CB) as a conductive agent, a polyvinylidene fluoride (PVDF) as a binder, and an N-methylpyrrolidone (NMP) as a dispersion medium. It is to be noted that the mass ratios of the positive active material, CB, and PVDF were set to be 93:4:3 (in terms of solid content). The positive composite paste was applied to one surface of an aluminum foil as a positive substrate, and dried. Thereafter, roll pressing was performed to obtain a positive electrode.

### Fabrication of Negative Electrode

A negative composite paste was prepared with the use of a mixture of silicon oxide (SiO) and graphite (Gr) as a negative active material, single-wall carbon nanotubes (CNT) as fibrous carbon, a carboxymethylcellulose (CMC) as a polysaccharide polymer, a polyacrylic acid (PAA) as a binder, and water as a dispersion medium. The mixing ratios of the negative active material, CNT, CMC, and PAA were set to be 96.65:0.05:0.10:3.20 (% by mass: in terms of solid content). The negative composite paste mentioned above was applied to one surface of a copper foil as a negative substrate, and dried. Thereafter, roll pressing was performed to obtain a negative electrode including a negative active material layer with the composition of the respective components mentioned above.

### Nonaqueous Electrolyte Solution

To a solvent obtained by mixing an ethylene carbonate, an ethyl methyl carbonate, and a dimethyl carbonate at 30:35:35 in volume ratio, 2.0% by mass of a fluoroethylene carbonate was added, and LiPF₆ was dissolved therein such that the salt concentration was 1.0 mol/dm³, thereby providing a nonaqueous electrolyte solution.

### Separator

A polyolefin microporous membrane was used for the separator.

### Assembly of Battery

The positive electrode, the negative electrode, and the separator were used to obtain an electrode assembly. The electrode assembly was housed in a case, and the nonaqueous electrolyte solution mentioned above was injected into the case to obtain a secondary battery (energy storage device) according to Example 1.

### Examples 2 to 5, Comparative Examples 1 to 4

Respective negative electrodes and secondary batteries according to Examples 2 to 5 and Comparative Examples 1 to 4 were obtained similarly to Example 1, except for the mixing ratios of the respective components for the negative composite paste as in Table 1. It is to be noted that in Table 1, the “SBR” represents styrene-butadiene rubber as a binder.

### Evaluation

### Charge-Discharge Cycle Test

The respective secondary batteries according to the examples and the comparative examples were subjected to the following charge-discharge cycle test at a temperature of 25° C. The charge was constant current charge with a current of 1.0 C and an end voltage of 4.25 V. The discharge was constant current discharge with a current of 1.0 C and an end voltage of 2.75 V. A rest period of 10 minutes was provided after each of the charge and the discharge. In each of examples and comparative examples, this charge-discharge was performed for 50 cycles. The ratio of the discharge capacity of the 50-th cycle to the discharge capacity of the first cycle was obtained as a capacity retention ratio (%). The results are shown in Table 1 and FIG. 3. It is to be noted that in FIG. 3, the respective results of Examples 1 to 4 and Comparative Examples 1 to 3 with only the PAA used as the binder are indicated by “●”, whereas the result of Example 5 with a small amount of SBR used together with the PAA as the binder is indicated by “▴”.

TABLE 1

| | Mixing Ratio (% by mass) | | | | | | | |
|---|---|---|---|---|---|---|---|---|
| | Negative | | | | | | | Capacity |
| | Active | | | | | Ratio by Mass | | Retention |
| | Material | CNT | CMC | PAA | SBR | CMC/PAA | CMC/CNT | Ratio (%) |
| Comparative | 96.65 | 0.05 | 0.00 | 3.30 | | 0.00 | 0 | 98.96 |
| Example 1 | | | | | | | | |
| Example 1 | 96.65 | 0.05 | 0.10 | 3.20 | | 0.03 | 2 | 99.00 |
| Example 2 | 96.65 | 0.05 | 0.50 | 2.80 | | 0.18 | 10 | 99.12 |
| Example 3 | 96.65 | 0.05 | 0.60 | 2.70 | | 0.22 | 12 | 99.13 |
| Example 4 | 96.65 | 0.05 | 0.80 | 2.50 | | 0.32 | 16 | 99.07 |
| Example 5 | 96.65 | 0.05 | 0.50 | 2.10 | 0.70 | 0.24 | 10 | 99.03 |
| Comparative | 96.65 | 0.05 | 1.20 | 2.10 | | 0.57 | 24 | 98.89 |
| Example 2 | | | | | | | | |
| Comparative | 96.65 | 0.05 | 1.50 | 1.80 | | 0.83 | 30 | 98.86 |
| Example 3 | | | | | | | | |
| Comparative | 96.65 | 0.05 | 1.20 | | 2.10 | — | 24 | 98.45 |
| Example 4 | | | | | | | | |

As shown in Table 1 and FIG. 3, each of the secondary batteries according to Examples 1 to 5 including the negative electrode in which the ratio by mass (CMC/PAA) of the CMC as a polysaccharide polymer to the PAA as an acrylic resin was 0.01 or more and 0.40 or less achieved a high value of 99.00% or more for the capacity retention ratio. In addition, the secondary battery according to Example 5 (▴ in FIG. 3) including a small amount of SBR together with the PAA as the binder resulted in a capacity retention ratio slightly decreased, for example, as compared with the secondary battery according to Example 2 that was equal in the total amount of the binder. The capacity retention ratio can be considered further increased by increasing the content ratio of the acrylic resin in the binder.

It is to be noted that the secondary battery according to Comparative Example 4 in which the SBR was used instead of the PAA used in Comparative Example 2 has the capacity retention ratio significantly decreased.

### INDUSTRIAL APPLICABILITY

The present invention can be applied to an energy storage device used as a power source for electronic devices such as personal computers and communication terminals, automobiles, and the like, and an electrode and the like provided in the nonaqueous electrolyte energy storage device.

### DESCRIPTION OF REFERENCE SIGNS

1: energy storage device

2: electrode assembly

3: case

4: positive electrode terminal

41: positive electrode lead

5: negative electrode terminal

51: negative electrode lead

20: energy storage unit

30: energy storage apparatus

1. An electrode for an energy storage device, the electrode comprising an active material layer containing an active material, fibrous carbon, a binder mainly containing an acrylic resin, and a polysaccharide polymer,
wherein a content ratio of the polysaccharide polymer to the acrylic resin on a mass basis is 0.01 or more and 0.40 or less.

2. The electrode according to claim 1, wherein a content ratio of the polysaccharide polymer to the fibrous carbon on a mass basis is 1 or more and 20 or less.

3. The electrode according to claim 1, wherein a content of the acrylic resin in the binder is 90% by mass or more.

4. The electrode according to claim 1, wherein a content of a styrene-butadiene rubber in the binder is 3% by mass or less.

5. The electrode according to claim 1, wherein the fibrous carbon includes a carbon nanotube.

6. The electrode according to claim 1, wherein the fibrous carbon has an average aspect ratio of 10 or more and 200 or less.

7. The electrode according to claim 1, wherein the fibrous carbon has an average diameter of 1 nm or more and 100 nm or less.

8. The electrode according to claim 1, wherein the fibrous carbon has an average length of 1 μm or more and 20 μm or less.

9. The electrode according to claim 1, wherein the polysaccharide polymer includes a cellulose derivative.

10. The electrode according to claim 1, wherein the active material includes an active material containing a silicon element.

11. The electrode according to claim 10, wherein the active material further includes a carbon material.

12. An energy storage device comprising the electrode according to claim 1.

13. An energy storage apparatus comprising a plurality of energy storage devices and one or more of the energy storage devices according to claim 12.
